(19) United States
(12) Patent Application Publication
(10) Pub. No.: US 2009/0071565 A1
(43) Pub. Date: Mar. 19, 2009

(54) MODULAR PRODUCTION DESIGN OF COMPRESSED NATURAL GAS COMPRESSOR AND MULTI-SATURATION LIQUEFIED NATURAL GAS DISPENSER SYSTEMS

(76) Inventor: Denis Ding, Riverside, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 12/209,990

(22) Filed: Sep. 12, 2008

Related U.S. Application Data
(60) Provisional application No. 60/993,599, filed on Sep. 13, 2007.

(51) Int. Cl. F17C 5/00; F17C 5/02; F17C 5/06; F17C 7/00

(52) U.S. Cl. 141/18; 141/4; 62/611; 222/3

(57) ABSTRACT

The present invention provides a modular natural gas compressor system for compressing natural gas so that it can be used to refuel motor vehicles. This system permits easy assembly and disassembly of compressor stations, as each individual compressor unit is shaped so that it will fit on a base structure. Specifically, the modular system is comprised of a prefabricated, mass produced base skid having at least one allowed space of standardized dimensions and at least one natural gas compressor unit, the base of which is shaped to fit in a allowed space of the base skid. Additional compressed natural gas compressor units or booster units, the bases of which are also shaped to fit in the allowed spaces of the base skid, may be added to increase the efficiency or functionality of the system. Liquefied natural gas dispenser units may also be designed to have bases that fit in the allowed spaces of the base skid, and can be added to the base skid to create a CNG compressor/LNG dispenser hybrid system. These liquefied natural gas dispenser units allow the user to select (automatically or manually) the level of saturation of the liquefied natural gas product to be dispensed by the dispenser.

### FIELD OF THE INVENTION

The present invention relates generally to compressors for compressed natural gas (CNG) stations and dispensers for liquefied natural gas (LNG) stations, both of which may be used to refuel motor vehicles, and more particularly to a modular design for CNG compressor and multi-saturation LNG dispenser systems.

### BACKGROUND OF THE INVENTION

Traditionally, compressed natural gas (CNG) compressor stations are custom-designed to accommodate specific site conditions and project locations. These stations take a long time to build and cannot be relocated easily because of their custom designs. The individual elements of these traditional stations cannot be pre-engineered or pre-produced—instead, as noted above, they are custom-designed to fit particular site locations and their unique conditions. As such, considerable time and expense is involved in producing, assembling, disassembling, and relocating CNG compressor stations. Furthermore, CNG compressor stations customarily are not combined with other natural gas stations, such as liquefied natural gas stations. As such, customers with differing natural gas needs must visit two different sites to purchase both liquefied and compressed natural gas products.

### SUMMARY OF THE INVENTION

Embodiments of the present invention provides a modular natural gas compressor system for compressing natural gas so that it can be used to refuel motor vehicles. This system permits easy assembly and configuration changes, as each individual compressor unit is shaped to fit on a base structure. Specifically, the modular system is comprised of a prefabricated base skid having two or more allowed spaces having predetermined and standardized dimensions and at least one natural gas compressor unit, the base of which is shaped to fit in the allowed spaces of the base skid.

This compressor system may further comprise one or more booster compressors, the bases of which are shaped to fit in the allowed spaces of the base skid, or it may include one or more additional natural gas compressors, the bases of which also are shaped to fit in the allowed spaces of the base skid.

Multi-saturation liquefied natural gas dispenser units may have bases that are shaped to fit in the allowed spaces of the base skid, and can be added to the base skid to create a CNG compressor/LNG dispenser hybrid system. This multi-saturation dispenser hybrid design may contain one or more dispensing nozzles coupled to each dispenser, as well as one or more LNG supply lines capable of connection to each liquefied natural gas dispenser. These LNG supply lines may carry two or more saturation levels of LNG, thus enabling customers to select different saturation levels of LNG to refuel their vehicles.

The liquefied natural gas dispensing system described above may also be controlled using an electronic device that can be coupled to the one or more LNG dispensers, wherein the electronic device enables customers to select the desired saturation levels of LNG. Other methods for selecting saturation levels may also be employed without departing from the scope of the invention, including but not limited to, (i) depressible buttons coupled to the one or more LNG dispensers, wherein the depressible buttons enable selection of saturation levels of LNG, and (ii) switch devices coupled to the one or more LNG dispensers, wherein the switch devices enable selection of saturation levels of LNG.

The present invention further provides a method for assembling a natural gas compressor system, comprising the steps of (i) providing a allowed base skid with two or more substantially identically-shaped, allowed spaces and (ii) coupling a natural gas compressor unit to the allowed base skid by placing it in one of the allowed spaces. This method can further comprise the step of coupling one or more additional natural gas compressor units, or one or more booster compressor units, to the allowed base skid by placing them in the allowed spaces. Alternatively, the method can comprise the step of coupling one or more liquefied natural gas compressors to the pre-formed base skid by placing them in the pre-formed spaces, wherein the liquefied natural gas compressors each have one or more dispensing nozzles.

In a situation in which multi-saturation LNG dispensers are installed in the allowed spaces with a CNG compressor unit, thus forming a hybrid CNG/LNG system, the method can also include the step of connecting the one or more LNG dispensers to one or more LNG supply lines, wherein the LNG supply lines carry at least two different saturation levels of LNG, thus enabling customers to receive LNG of varying saturations at the same fueling station. This method can enable customers to select the desired saturation level of LNG by further comprising the step of coupling to the liquefied natural gas compressors means for selecting saturation levels of liquefied natural gas. Such means may include electronic signaling devices employing wireless technology or radio waves, buttons or switches that can be depressed and/or toggled, and other means described herein.

Other features and advantages of the present invention should become apparent from the following description of the preferred embodiments, taken in conjunction with the accompanying drawings, which illustrate, by way of example, the principles of the invention.

### BRIEF DESCRIPTION OF THE DRAWINGS

The present invention, in accordance with one or more various embodiments, is described in detail with reference to the following figures. The drawings are provided for the purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 is a representative diagram of a base skid with allowed spaces of standardized dimensions.

FIGS. 2A-2E are schematic diagrams of base skids with allowed spaces and various means for securing compressor units within the allowed spaces.

FIG. 3 is a side-view, cross-sectional schematic diagram of a base skid containing a CNG compressor.

FIG. 4 is a side-view, cross-sectional schematic diagram of a base skid containing a CNG compressor and a booster unit.

FIG. 5 is a side-view, cross-sectional schematic diagram of a base skid containing two CNG compressors.

FIG. 6 is a side-view schematic diagram of an LNG dispenser coupled to a nozzle and LNG supply lines.

FIG. 7 is a side-view, cross-sectional schematic diagram of a base skid containing a CNG compressor and an LNG dispenser coupled to a nozzle and an LNG supply line.

### DETAILED DESCRIPTION OF THE PREFERRED EMBODIMENTS

In the following paragraphs, the present invention will be described in detail by way of example with reference to the attached drawings. Throughout this description, the preferred embodiment and examples should be considered as exemplars, rather than as limitations on the present invention. As used herein, the term “present invention” refers to any one of the embodiments of the invention described herein, and any equivalents. Furthermore, reference to various feature(s) of the present invention throughout this document does not mean that all claimed embodiments or methods must include the referenced feature(s).

The present invention is directed to a modular compressed natural gas (CNG) compressor that can be used in connection with a CNG station for refueling motor vehicles. In particular, the invention involves a modular CNG compressor system that uses a standard base skid to house compressor and booster units, and can be hybridized by adding liquefied natural gas (LNG) dispensers which, when coupled to LNG supply lines, can dispense liquefied natural gas. The base skid may be mass manufactured from a sturdy material, including but not limited to metal alloys, rubber, plastic, or a combination of such materials, and contains two or more slots, spaces, or openings with standardized dimensions for receiving compressor or dispenser units. The compressor and booster units and liquid natural gas dispensers are manufactured so that their base structure fits within the standardized spaces of the standard base skid. The standard base skid can be pre-produced at a factory and compressor or booster units can be added as needed. The modular nature of this system streamlines the production of compressor skids and increases the speed at which compressor stations can be installed at project sites. This system also facilitates faster relocation, as compressor and booster units and liquid natural gas dispensers may be quickly and easily removed from the base skid. In a situation where a compressor system needs to be relocated, the system can be dismantled and each part can be shipped to the new location, and then reassembled at the new location.

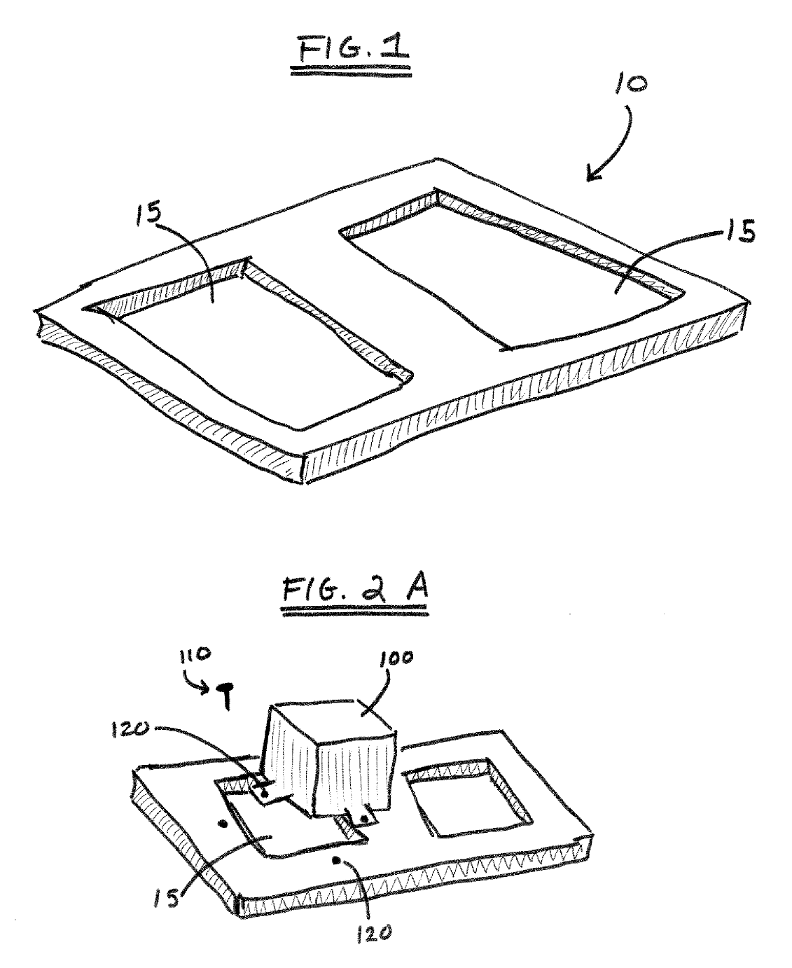

Referring to FIG. 1, in accordance with the principles of the invention, an example base skid 10 design is illustrated having several allowed spaces 15 that can house compressor, booster, and dispenser units. The base skid 10 illustrated in this figure is not intended to be limiting, as it may contain any number of allowed spaces—it is limited only by the requirement that there be at least one allowed space. The allowed spaces 15 may be of standardized dimensions, such as 10 feet by 20 feet by 1 foot, or any dimensions desired by the manufacturer. For example, if a compressor or booster unit can be no smaller than 10 feet wide by 15 feet long by 2 feet deep, the base skid spaces 15 can be designed to meet those measurements and house the desired compressor or booster units. The allowed spaces 15 may be of any shape that can house an upgrade unit to be inserted. For example, though the allowed spaces 15 depicted in FIG. 1 are rectangular in shape, they may be circular, parabolic, rhomboid, triangular, square, or any other shape that can house an upgrade unit with a matching base shape. Each of the embodiments described in this application and encompassed by the claims may utilize a base skid with the characteristics described in this disclosure.

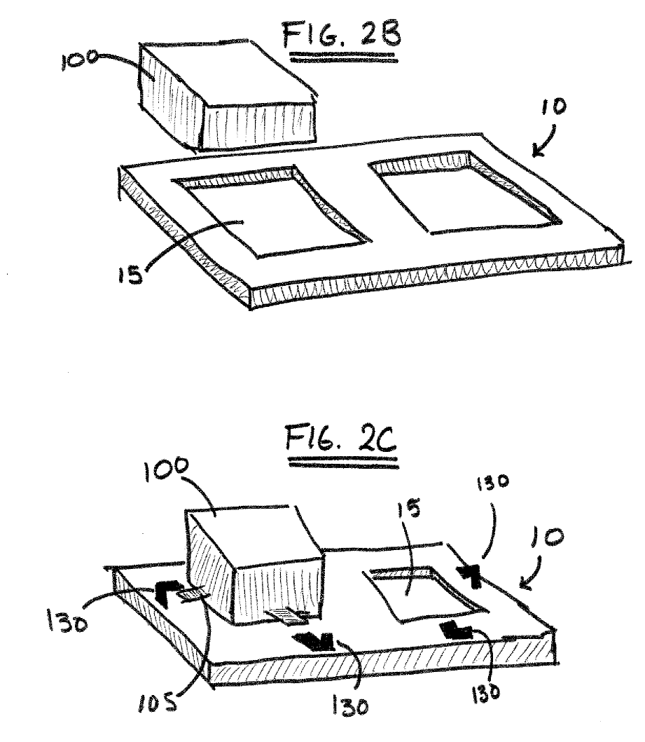

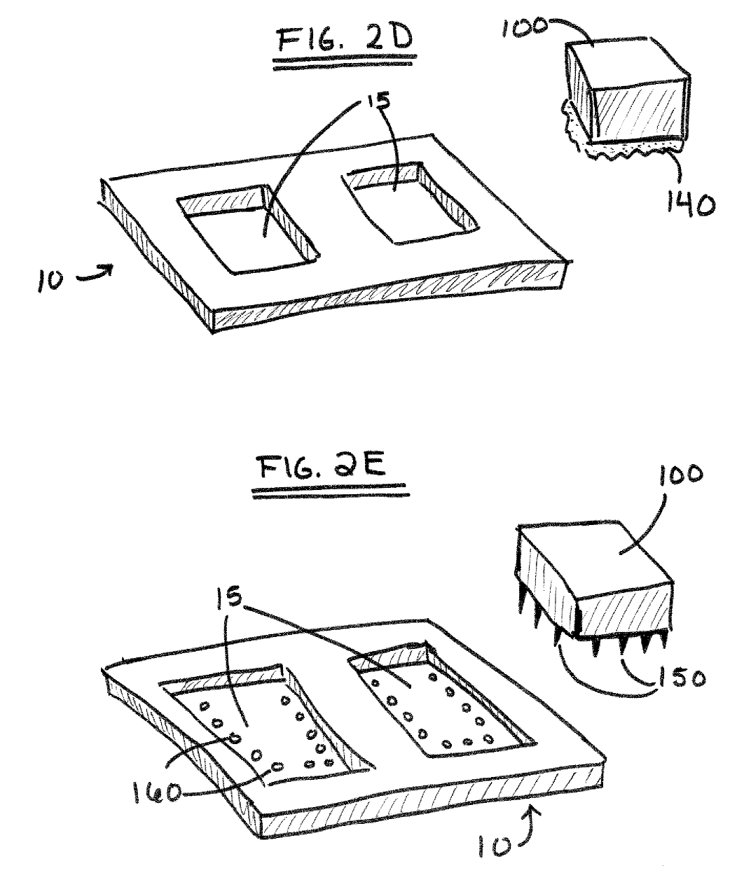

Referring to FIGS. 2A-E, in accordance with the principles of the invention, various methods of affixing modular compressor, booster, and dispenser units on base skids are illustrated. These methods may be employed by any and all of the embodiments described in this application. These methods are meant to be merely illustrative, and are not intended to be limiting, as this disclosure contemplates the use of any and all methods known in the art of affixing or securing compressor or dispenser units to base skids.

In FIG. 2A, the base of an upgrade unit 100, which may be a compressor, booster, or dispenser unit, is placed in one of the allowed spaces 15. The upgrade unit 100 may be secured therein by inserting screws or bolts 110 into appropriately-sized holes 120 located at various points on both the upgrade unit 100 and the base skid 10 proximate to the space 15. These screws or bolts 110 should be removable to ensure that, when the assembly needs to be modified or moved, the compressor booster, or dispenser unit can be detached easily from the base skid 10.

Referring to FIG. 2B, the unit 100 may also be secured within the space 15 via friction; the base of the unit 100 may be sized such that it is only slightly smaller than the area of the space 15 and will be held within the space 15 by friction between the material of the base skid 10 and the material of the unit 100.

Referring to FIG. 2C, the unit 100 may also be secured within the space 15 by utilizing snap elements 130 affixed to the base skid 10 at various locations proximate to the space 15. When the unit 100 is placed within the space 15, the snap elements 130 can be rotated or twisted or otherwise engaged such that they overlap with an extruding (or indented) section 105 of the unit 100 and thereby hold the unit 100 in place within the space 15. In FIG. 2C, the unit 100 is disposed within a space 15 of the base skid 10 before the snap elements 130 have been applied to the extruding section 105 of the unit 100.

Referring to FIG. 2D, the unit 100 may also be secured within the space 15 by utilizing dissolvable cement or glue 140 that can be poured or applied to the interior of the space 15 or the exterior of the base element of the unit 100 before the unit 100 is inserted into the space 15, and which sets and adheres the unit 100 within the space 15 until a solution that destroys the glue's 140 adhesive properties is applied. In FIG. 2D, the unit 100 is depicted with glue 140 applied to its base prior to being inserted into one of the allowed spaces 15.

Referring to FIG. 2E, the unit 100 may also be secured within the space 15 by affixing numerous extrusions 150 to the base of the unit 100 that will fit within indentations 160 of matching size and dimensions within the space 15 on the base skid 10. When the extrusions 150 are fitted within the indentations 160, the resulting friction between these two elements will serve to lock the unit 100 into place within the space 15. Other means of securing the upgrade unit 100 may be employed without departing from the scope of the invention.

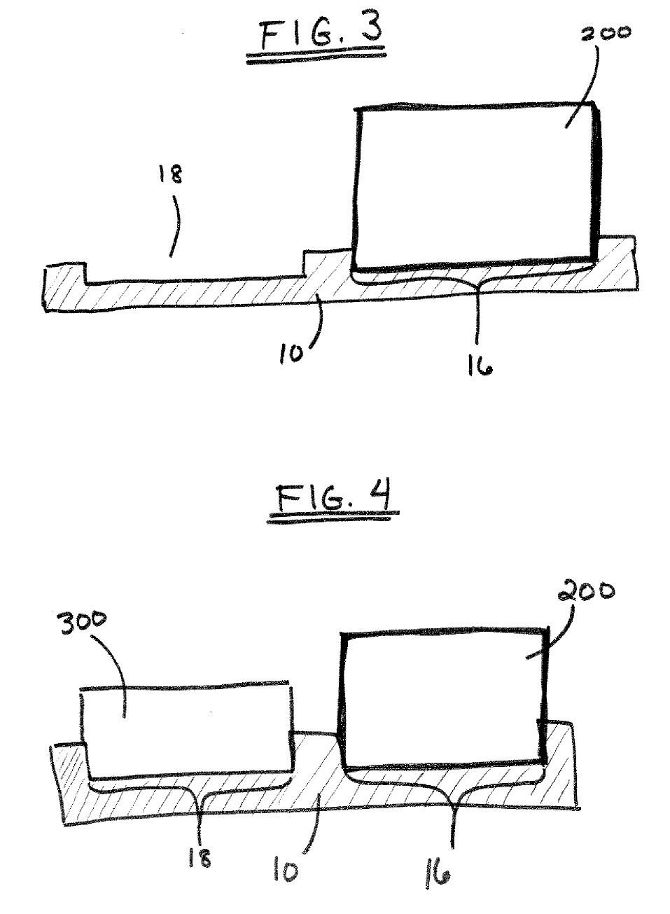

Referring to FIG. 3, in accordance with the principles of the invention, a compressor system (“Model A”) is illustrated having a base skid 10 and compressed natural gas compressor unit 200. As illustrated, the compressed natural gas compressor unit 200 fits into one of the allowed spaces 16 of the base skid 10, leaving another space 18 available for another compressor, booster, or dispenser unit. By leaving at least one other space 18 available, the system can be upgraded to a dual compressor system or flexible capacity system by adding a booster upstream of the compressor, or it may be upgraded to a hybrid CNG compressor/LNG dispenser system. These figures are not meant to limit the scope of the invention, as the base skid 10 may contain more than two allowed spaces that can house additional compressor or dispenser units.

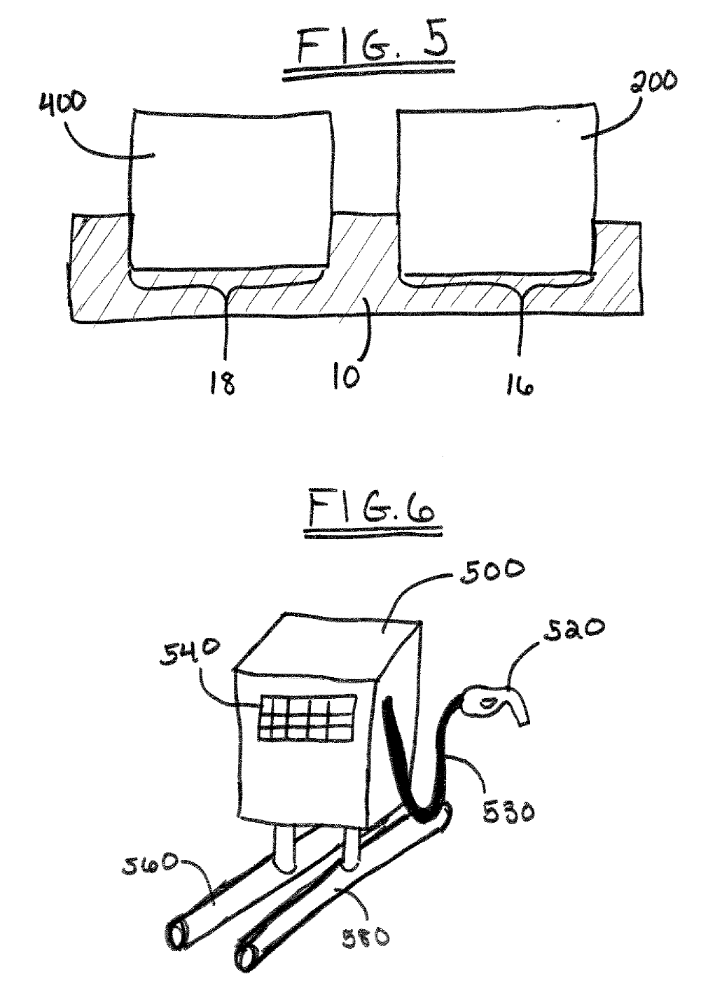

Referring to FIG. 4, in accordance with the principles of the invention, another compressor system (“Model B”) is illustrated having a base skid 10, a CNG compressor 200 in one of the allowed spaces 16, and a booster compressor unit 300 in another allowed space 18. The booster unit 300 is a useful addition to the CNG system because it permits the CNG compressor unit 200 to accept a larger range of inlet gas pressures and gives the CNG compressor unit 200 the ability to control and increase gas flow capacity and power consumption. Similar to the previous embodiment, these figures are not meant to limit the scope of the invention, as the base skid 10 may contain more than two allowed spaces that can house additional compressor dispenser units.

Referring to FIG. 5, in accordance with the principles of the invention, another compressor system (“Model C”) is illustrated having a base skid 10, a CNG compressor 200 in one of the allowed spaces 16, and a second CNG compressor unit 400 in another allowed space 18. The second CNG compressor unit 400 is a useful addition to the CNG system because it gives the system compression redundancy, i.e., it increases the efficiency of compression within the system. Similar to previous embodiments, these figures are not meant to limit the scope of the invention, as the base skid 10 may contain more than two allowed spaces that can house additional compressor or dispenser units.

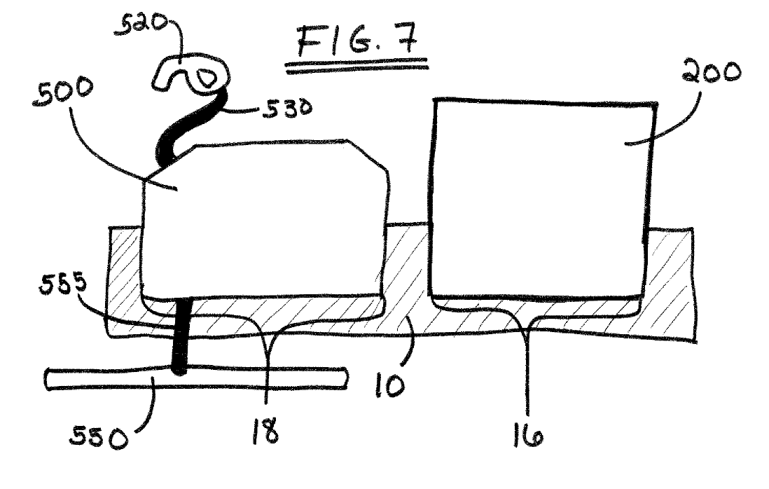

Referring to FIG. 6, in accordance with the principles of the invention, an LNG dispenser 500 is illustrated coupled to a nozzle 520 by a hose 530. The LNG dispenser 500 is also coupled to a selection device 540, which enables customers to select the type of LNG they wish the dispenser 500 to dispense through the hose 530 and nozzle 520. The LNG dispenser illustrated in this figure is coupled to two LNG supply lines 560, 580, which may carry two or more different saturation levels of LNG. This figure is not meant to limit the scope of the invention, as there may be more than two LNG supply lines and/or nozzles coupled to the LNG dispenser 500 carrying two or more different saturation levels of LNG.

With further reference to FIG. 6, LNG saturation levels can be selected by a customer using the selection device 540. This selection device 540 may operate in many different ways, which will be apparent to one of ordinary skill in the art. For example, the selection device 540 may include an LCD screen or other display for viewing electronic information, a credit card reader or cash entry slot to allow customers to pay for the LNG being dispensed, and a series of depressible buttons or flippable switches that a customer can manually press or flip to select the desired LNG saturation level. In the alternative, the selection device 540 may include an electronic reader that uses electronic signals to detect information contained on a credit card, access or proximity card, or fob regarding the LNG saturation level desired by the customer such that the customer need not physically touch the selection device 540 to select a LNG saturation level. The selection device 540 may also contain wireless telephone capabilities such that a customer can select an LNG saturation level by dialing a telephone number assigned to the selection device 540, connecting to the selection device 540, and selecting the desired LNG saturation level by issuing commands to the selection device 540 using the customer's telephone, such as a cellular phone. The embodiments described above are not intended to be limiting and the selection device 540 may operate in any number of ways known in the art.

Referring to FIG. 7, in accordance with the principles of the invention, a hybrid CNG compressor/LNG dispenser system is illustrated having a base skid 10, a CNG compressor 200 disposed in one of the preformed spaces 16, and an LNG dispenser 500 disposed in another pre-formed space 18. The LNG dispenser 500 is connected to an LNG supply line 550 through a connection hose 555 intersecting the base skid 10 and can dispense LNG through a hose 530 and nozzle 520. Similar to previous embodiments, this figure is not meant to limit the scope of the invention, as the base skid 10 may contain more than two pre-formed spaces that can house additional compressor or dispenser units, and the LNG dispenser unit 500 may be connected to any number of LNG supply lines containing LNG of varying saturation levels.

While various embodiments of the present invention have been described above, it should be understood that they have been presented by way of example only, and not of limitation. Likewise, the various diagrams may depict an example architectural or other configuration for the invention, which is done to aid in understanding the features and functionality that may be included in the invention. The invention is not restricted to the illustrated example architectures or configurations, but the desired features may be implemented using a variety of alternative architectures and configurations. Indeed, it will be apparent to one of skill in the art how alternative functional, logical, or physical partitioning and configurations may be implemented to implement the desired features of the present invention. Also, a multitude of different constituent module names other than those depicted herein may be applied to the various partitions. Additionally, with regard to method claims, the order in which the steps are presented herein shall not mandate that various embodiments be implemented to perform the recited functionality in the same order unless the context dictates otherwise.

Terms and phrases used in this document, and variations thereof; unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms ‘a’ or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A modular natural gas compressor system, comprising:
a base skid having two or more allowed spaces; and
a natural gas compressor unit, the base of which is shaped to fit in one of the allowed spaces of the base skid.

2. The system of claim 1, further comprising at least one booster compressor, the base of which is shaped to fit in one of the allowed spaces of the base skid.

3. The system of claim 1, further comprising at least one additional natural gas compressors, the base of which is shaped to fit in one of the allowed spaces of the base skid.

4. The system of claim 1, further comprising at least one liquefied natural gas dispensers, the base of which is shaped to fit in one of the pre-formed spaces of the base skid.

5. The system of claim 4, further comprising a dispensing nozzle coupled to each liquefied natural gas dispenser.

6. The system of claim 5, further comprising one or more liquefied natural gas supply lines capable of connection to the one or more liquefied natural gas dispensers.

7. The system of claim 6, wherein the one or more liquefied natural gas supply lines carry at least two different saturation levels of liquefied natural gas.

8. The system of claim 6, further comprising an electronic device coupled to the one or more liquefied natural gas dispensers, wherein an electronic reading enables selection of different saturation levels of liquefied natural gas.

9. The system of claim 7, further comprising depressible buttons coupled to the one or more liquefied natural gas dispensers, wherein the depressible buttons enable selection of different saturation levels of liquefied natural gas.

10. The system of claim 7, further comprising switch devices coupled to the one or more liquefied natural gas dispensers, wherein the switch devices enable selection of different saturation levels of liquefied natural gas.

11. A method for assembling a natural gas compressor system, comprising the steps of:
providing a allowed base skid with two or more substantially identically-shaped, allowed spaces; and
coupling a natural gas compressor unit to the allowed base skid by placing it in one of the allowed spaces.

12. The method of claim 11, further comprising the step of coupling at least one additional natural gas compressor unit to the allowed base skid by placing it in a allowed space.

13. The method of claim 11, further comprising the step of coupling at least one booster compressor to the allowed base skid by placing it in a allowed space.

14. The method of claim 11, further comprising the step of coupling at least one liquid natural gas compressor to the pre-formed base skid by placing it in a pre-formed space, wherein the liquid natural gas compressor has one or more dispensing nozzles.

15. The method of claim 14, further comprising the step of connecting the liquid natural gas compressor to one or more liquid natural gas supply lines, wherein the liquid natural gas supply lines carry at least two different saturation levels of liquid natural gas.

16. The method of claim 15, further comprising the step of coupling to the liquid natural gas compressor a means for selecting saturation levels of liquid natural gas.
